(19) United States
(12) Patent Application Publication
(10) Pub. No.: US 2026/0322700 A1
(43) Pub. Date: Oct. 15, 2026

(54) METHODS AND APPARATUS FOR CONNECTION SETUP AND/OR RESUME IN WIRELESS NETWORKS

(71) Applicant: InterDigital Patent Holdings, Inc., Wilmington, DE (US)

(72) Inventors: Oumer Teyeb, Montreal (CA); Yugeswar Deenoo Narayanan Thangaraj, Chalfont, PA (US); Dylan Watts, Montreal (CA)

(21) Appl. No.: 19/116,633

(22) PCT Filed: Sep. 26, 2023
(86) PCT No.: PCT/US2023/033666

§ 371 Date: Mar. 28, 2025

Related U.S. Application Data
(60) Provisional application No. 63/410,759, filed on Sep. 28, 2022.

(51) Int. Cl. H04L 41/147; H04L 41/16; H04W 76/27

(52) U.S. Cl. CPC H04L 41/147; H04L 41/16; H04W 76/27

(57) ABSTRACT

Methods and apparatus for connection setup and/or resume in a wireless network, e.g., using different device identity sets depending on network and/or device conditions, are provided. One method may include receiving first information indicating a plurality of WTRU identities and second information indicating one or more associations between each of the plurality of identities and at least one condition. The method may include determining one or more of the current WTRU conditions, the current network conditions, the predicted WTRU conditions, and the predicted network conditions. Based on the associations, the method may include determining a WTRU identity that is associated with one or more of: the determined current conditions at the WTRU, the determined predicted conditions at the WTRU, the determined current conditions at the network, and the determined predicted conditions at the network. The determining of the WTRU identity may be performed while the WTRU is operating in a power saving state such as IDLE or INACTIVE state. The method may then include sending, to the network, an indication of the determined WTRU identity. The sending of the indication of the determined WTRU identity may be performed upon transitioning from the power saving state to a non-power saving state such as a CONNECTED state.

### CROSS-REFERENCE TO RELATED APPLICATIONS

This application claims the benefit of U.S. Provisional Patent Application No. 63/410,759, filed Sep. 28, 2022; the contents of this application is incorporated herein by reference in its entirety.

### FIELD

This disclosure pertains to methods and apparatus for connection setup and/or connection resume in a wireless network using different device identity sets depending on network and/or device conditions.

### SUMMARY

An embodiment may be directed to a method, which may include receiving, by a wireless transmit/receive unit (WTRU), first information indicating a plurality of WTRU identities and receiving second information indicating one or more associations between (i) each of the plurality of WTRU identities and (ii) at least one condition. The at least one condition may include at least one of current conditions and/or predicted conditions at any of the WTRU and the network. The method may include determining one or more of the current conditions at the WTRU, the current conditions at the network, the predicted conditions at the WTRU, and/or the predicted conditions at the network. Based on the associations, the method may include determining, by the WTRU, a WTRU identity that is associated with one or more of: the determined current conditions at the WTRU, the determined predicted conditions at the WTRU, the determined current conditions at the network, and/or the determined predicted conditions at the network. The method may also include transmitting, to the network, an indication of the determined WTRU identity.

An embodiment may be directed to a WTRU that may include circuitry, which may include one or more of a transmitter, receiver, processor and/or memory. The circuitry may be configured to receive first information indicating a plurality of WTRU identities and receive second information indicating one or more associations between (i) each of the plurality of WTRU identities and (ii) at least one condition. The at least one condition may include at least one of current conditions and/or predicted conditions at any of the WTRU and the network. The circuitry may be configured to determine one or more of the current conditions at the WTRU, the current conditions at the network, the predicted conditions at the WTRU, and/or the predicted conditions at the network. Based on the associations, the circuitry may be configured to determine a WTRU identity that is associated with one or more of: the determined current conditions at the WTRU, the determined predicted conditions at the WTRU, the determined current conditions at the network, and/or the determined predicted conditions at the network. The circuitry may be configured to transmit, to the network, an indication of the determined WTRU identity.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signal flow diagram illustrating an RRC connection/establishment procedure;

FIG. 3 is a signal flow diagram illustrating a connection resume procedure;

FIG. 4 is a transition diagram illustrating the different RRC states of a WTRU and the transitions between them;

FIG. 5A is a signal flow diagram illustrating messaging exchange for a 4-step random access procedure;

FIG. 5B is a signal flow diagram illustrating messaging exchange for a 2-step random access procedure;

FIG. 6 is a flowchart illustrating a process for network connection setup/resume in accordance with some embodiments;

FIG. 7 is an example signal flow diagram illustrating a process for connection setup or connection resume in a wireless network using different WTRU identities or identity sets depending on network and/or WTRU conditions, according to an embodiment; and

FIG. 8 is an example flowchart of a method of connection setup or connection resume, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

### Example Communication Systems

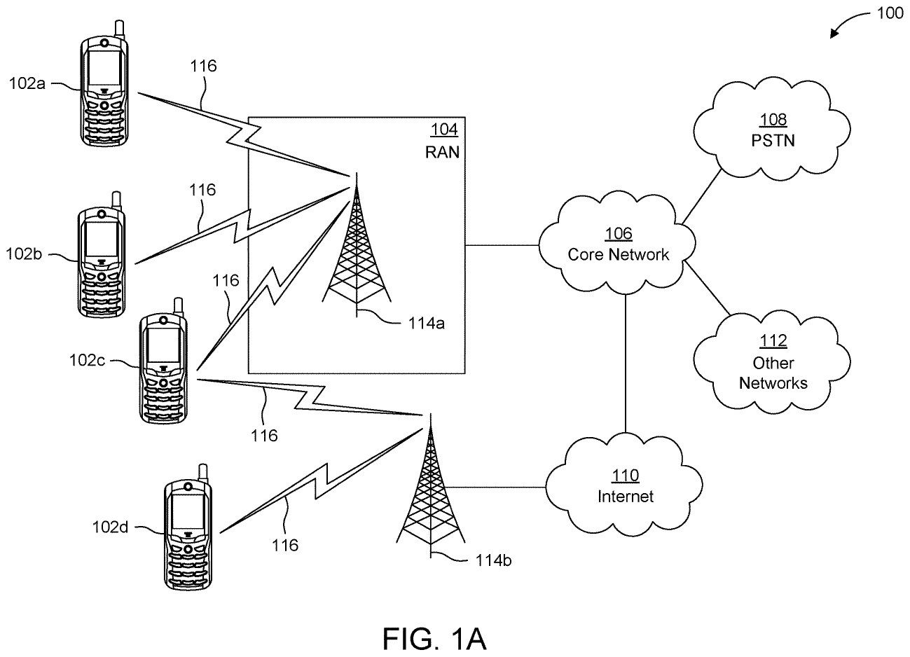

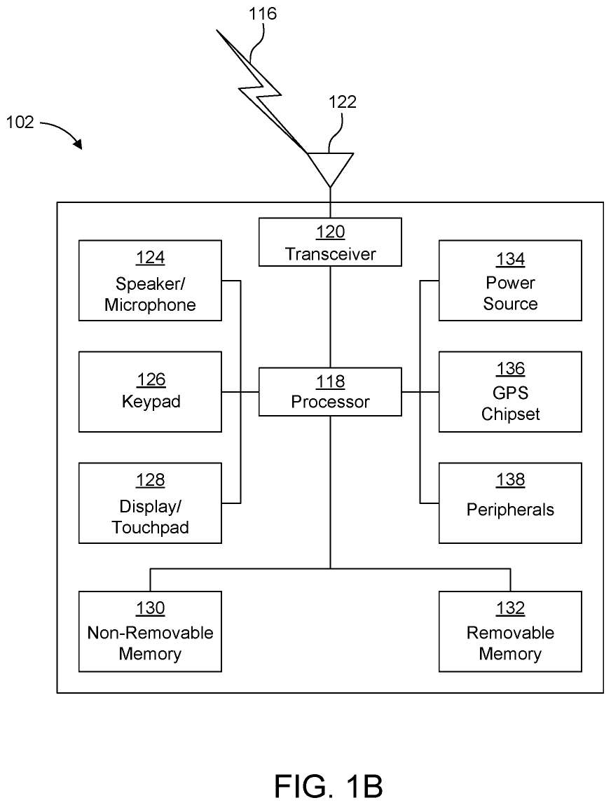

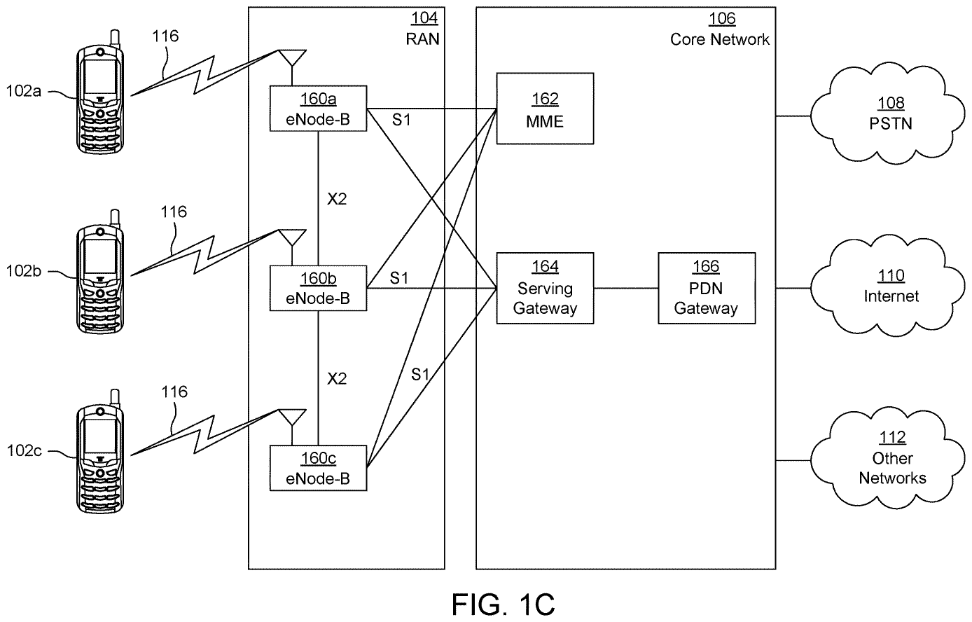

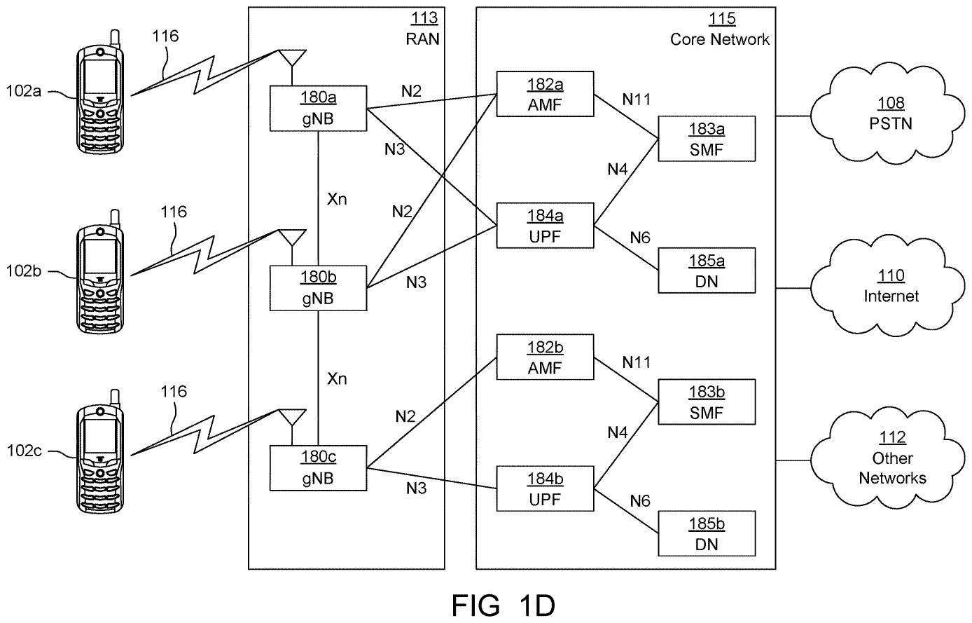

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Packet Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### WTRU Connection States and Random Access Procedures

### RRC Connection States and State Transitions

In NR, a WTRU can be in one of the following three RRC states: RRC_CONNECTED (which may also be referred to as “connected mode” or the like in this document), RRC_INACTIVE (which may also be referred to as “inactive mode” or the like in this document, and/or RRC_IDLE (which may also be referred to as “idle mode” or the like in this document).

In RRC_CONNECTED, the WTRU is actively connected to the network, with signaling and data radio bearers established (SRB and DRBs). It is able to receive Downlink (DL) data from the network in a unicast fashion and also send Uplink (UL) data to the network. The mobility of the WTRU from one cell/node to another is controlled by the network. The network may configure the WTRU to send measurement reports periodically or when certain conditions are fulfilled (e.g., a neighbor cell becomes better than a serving cell by more than a certain threshold). Based on these reports, the network may send the WTRU a handover command to move the WTRU to another cell/node. The network may also configure a conditional handover (CHO) where, instead of sending of a measurement report, the WTRU executes a preconfigured handover command when certain conditions are fulfilled. The network may also send the WTRU a Handover (HO) command without receiving any measurement report (e.g., based on implementation, such as the determination of current location).

Keeping the WTRU in connected mode is power intensive for the WTRU (e.g., the WTRU needs to continuously monitor the PDCCH of the serving cell, e.g., for determining the arrival of DL data, for UL data scheduling, etc.). Furthermore, a certain cell/gNB is able to accommodate a certain number of WTRUs in connected mode (e.g., due to resource limitations). As such, when there is no activity in the UL or DL for a WTRU for a certain duration (e.g., based on an inactivity timer kept at the network), the network may send the WTRU to the RRC_INACTIVE or RRC_IDLE state.

If the network expects the WTRU to become active for an extended period of time, it may send the WTRU to RRC_IDLE state. While in RRC_IDLE, the WTRU camps at the best cell (the cell with the best signal level at the highest priority RAT and highest priority frequency within that RAT) that will facilitate the WTRU establishing the connection via that cell if a need arises for the WTRU to transition back to the connected state. More details of the cell re-selection procedure that ensures the WTRU is camping (e.g., is always camping) at the best cell is discussed below. The WTRU may also monitor the downlink paging channel to monitor for DL data arrival. The WTRU may initiate the connection setup and/or establishment procedure if it detects a paging from the network indicating an arrival of DL data or if the WTRU needs to send UL data.

During connection setup or resume, the WTRU first performs a random access (RA) procedure (also referred to as Random Access Channel (RACH) procedure in this disclosure) before sending an RRCSetupRequest or RRCResumeRequest message. The RA procedure may serve two main purposes: (1) UL synchronization between the WTRU and the network (e.g., gNB), and (2) obtaining the resources that are to be used for sending the request message.

During the RA procedure, the WTRU sends a message on the RACH (referred to as msg1), that contains a Preamble and an RA-RNTI (Random Access-Radio Network Temporary Identifier) to the gNB. In the case of contention based random access (CBRA), the preamble is randomly selected out of a set of possible preamble values (i.e., there could be a contention if another WTRU initiates a random access procedure using the same preamble value). In the case of contention free random access (CFRA), a specific preamble is provided to the WTRU beforehand (e.g., when the WTRU was in CONNECTED state, during the transition to the IDLE/INACTIVE state, etc.). The RA-RNTI is calculated based on the PRACH (physical RACH) occasion at which the random access message is to be sent to the network.

The gNB, upon receiving msg1, responds with msg2, which contains a Random Access Response (RAR). In order for the WTRU to detect the RAR, the network also sends a DCI (Downlink Control Indicator) in the PDCCH that is scrambled with the RA-RNTI, and which is used by the WTRU to determine on which resources (i.e., time and frequency) that RAR (and other related info) is provided to the WTRU. The WTRU tries to detect this DCI within a period of time after sending the preamble (known as the RAR-window). If such DCI is not received, the WTRU may retransmit the preamble. If the DCI is received, the WTRU will receive the RAR at the indicated time and frequency resources in the Physical Downlink Shared Channel (PDSCH). In the RAR and associated information, the WTRU will be provided with the timing advance (TA) to apply for sending UL data, the TC-RNTI (temporary Cell RNTI), and the UL resources to send the setup/resume request message.

The WTRU may get the detailed information/configuration regarding the usage of the random access channel, such as RACH occasion, random access response window, etc., via dedicated configuration while in CONNECTED state, upon transitioning during an IDLE/INACTIVE state, or from a system information broadcast (SIB).

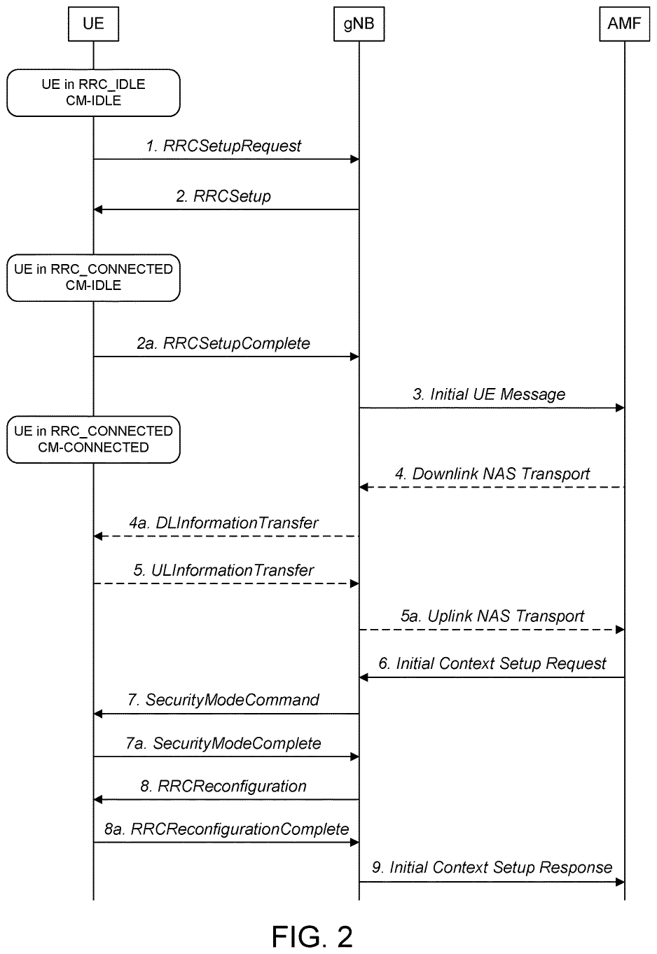

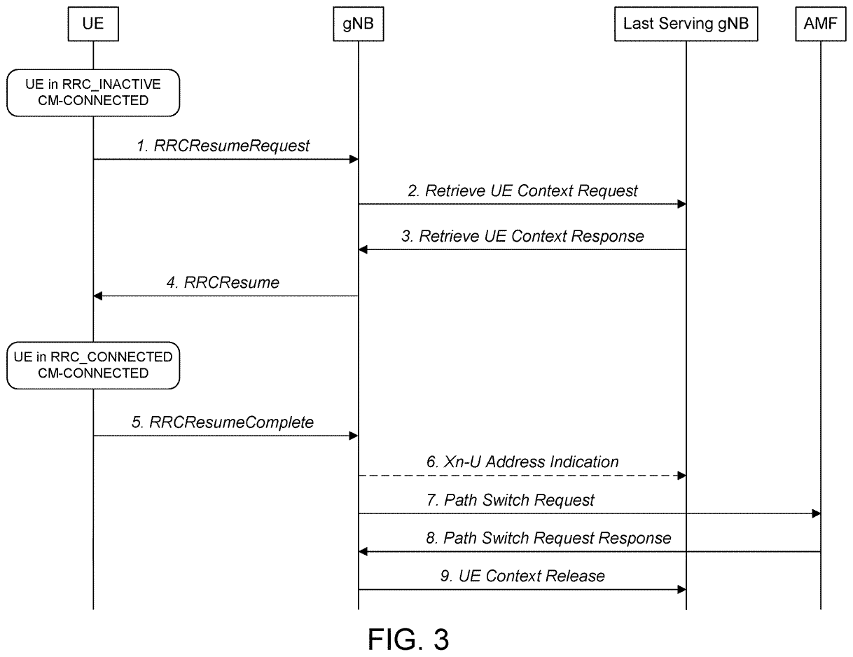

FIGS. 2 and 3 illustrate the RRC connection establishment/setup and connection resume procedures, respectively, as set forth in TS38.300 [1], sections 9.2.1.3 and 9.2.2.4.1, respectively.

The RA procedure is not shown in these FIGS., e.g., msg1 and msg 2. However, some of the follow up signaling, e.g., msg3, msg4, and msg5, are shown. For sake of clarity, note that: msg3 corresponds to a message sent after the RA response is received from the gNB (e.g., RRCResumeRequest or RRCSetupRequest); msg4 corresponds to a response from the network to a msg3 sent from the UE (e.g., RRCResume or RRCSetup); and msg5 corresponds to the confirmation from the UE that the msg4 was executed properly (e.g., RRCResumeComplete or RRCSetupComplete). Also note that, if the WTRU resumes the connection in the same gNB, messages between the two gNBs and also between the gNB and the Core Network (CN) will not be required, and, as such, the WTRU can be resumed without involving the CN.

As can be seen in the above, the RRC connection setup procedure is a lengthy procedure that requires several round trip times to complete and involves the CN. This is because when the WTRU enters IDLE mode, the WTRU's RRC context is released, and as such the WTRU is not known to the cellular network at the RAN level. Thus, the RAN must obtain the WTRU context from the CN. Also, security must be re-established after that and the WTRU reconfigured with the DRBs and SRBs, before UL/DL data transmission/reception may occur.

Such a lengthy setup procedure is not compatible with low latency services and thus NR has introduced an intermediate state between the CONNECTED and IDLE state, known as the INACTIVE state. This state has most of the power saving advantages of the IDLE state (e.g., WTRU does not need to continuously monitor the PDCCH, which is one of the most power consuming procedures in the CONNECTED state), but at the same time, the RAN still keeps the WTRU's RRC/Security context. When there is a need to transition the WTRU to CONNECTED mode (e.g., due to the arrival of UL data or the reception of a paging indicating the arrival of DL data), the connection can be resumed very quickly, without involving the CN, re-establishing the WTRU's security context, and reconfiguring the bearers.

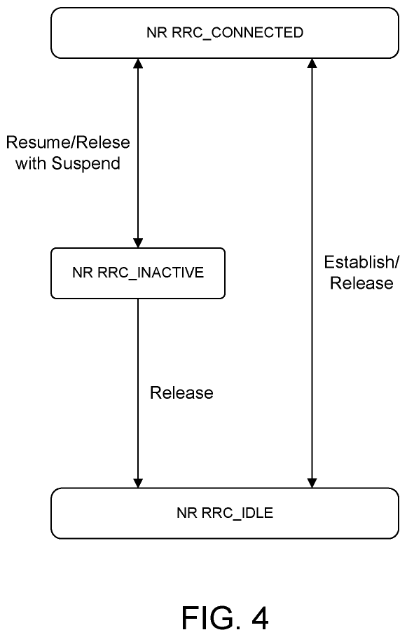

FIG. 4 summarizes the different RRC states and the transitions between them.

The ASN. 1 message definitions of the RRC Setup and RRC Resume Request messages are shown below.

### RRCSetupRequest

The RRCSetupRequest message is used to request the establishment of an RRC
connection.
Signalling radio bearer: SRB0
RLC-SAP: TM
Logical channel: CCCH
Direction: WTRU to Network

RRCSetupRequest message

| -- ASN1START | |
|---|---|
| -- TAG-RRCSETUPREQUEST-START | |
| RRCSetupRequest ::= | SEQUENCE { |
| rrcSetupRequest | RRCSetupRequest-IEs |
| } | |
| RRCSetupRequest-IEs ::= | SEQUENCE { |
| ue-Identity | InitialUE-Identity, |
| establishmentCause | EstablishmentCause, |
| spare | BIT STRING (SIZE (1) ) |
| } | |
| InitialUE-Identity ::= | CHOICE { |
| ng-5G-S-TMSI-Part1 | BIT STRING (SIZE (39) ), |
| randomValue | BIT STRING (SIZE (39) ) |

}
-- TAG-RRCSETUPREQUEST-STOP
-- ASN1STOP

### RRCResumeRequest

The RRCResumeRequest message is used to request the resumption of a suspended RRC connection or perform an RNA update.
Signalling radio bearer: SRB0
RLC-SAP: TM
Logical channel: CCCH
Direction: WTRU to Network

RRCResumeRequest message

| -- ASN1START | |
|---|---|
| -- TAG-RRCRESUMEREQUEST-START | |
| RRCResumeRequest ::= | SEQUENCE { |
| rrcResumeRequest | RRCResumeRequest-IEs |
| } | |
| RRCResumeRequest-IEs ::= | SEQUENCE { |
| resumeIdentity | ShortI-RNTI-Value, |
| resumeMAC-I | BIT STRING (SIZE (16) ), |
| resumeCause | ResumeCause, |
| spare | BIT STRING (SIZE (1) ) |

}
-- TAG-RRCRESUMEREQUEST-STOP
-- ASN1STOP

### RRCResumeRequest1

The RRCResumeRequest1 message is used to request the resumption of a suspended RRC connection or perform an RNA update.
Signalling radio bearer: SRB0
RLC-SAP: TM
Logical channel: CCCH1
Direction: WTRU to Network

RRCResumeRequest1 message

| | |
|---|---|
| -- ASN1START | |
| -- TAG-RRCRESUMEREQUEST1-START | |
| RRCResumeRequest1 ::= | SEQUENCE { |
| rrcResumeRequest1 | RRCResumeRequest1-IEs |
| } | |
| RRCResumeRequest1-IEs ::= | SEQUENCE { |
| resumeIdentity | I-RNTI-Value, |
| resumeMAC-I | BIT STRING (SIZE (16) ), |
| resumeCause | ResumeCause, |
| spare | BIT STRING (SIZE (1) ) |
| } | |
| -- TAG-RRCRESUMEREQUEST1-STOP | |
| -- ASN1STOP | |

When the WTRU is sent to INACTIVE state, the network includes in the RRCRelease message a suspendConfig. The SuspendConfig may contain information such as: the resumeIdentity to be used by the WTRU, the RAN paging area, and/or nextHopChaining count. The resumeIdentity to be used by the WTRU may include a short identity (e.g., shortl-RNTI (24 bits) and/or a long identity (e.g., full-RNTI (40 bits)). The WTRU may determine which identity to use (e.g., short or long identity) based on the system information broadcast in the target cell (e.g., if useFullResumeID is indicated in the SIB, use the long identity, otherwise, use the short identity). The RAN paging area (e.g., list of cells) may refer to the RAN area where the WTRU can be paged at RAN level. If the WTRU performs cell re-selection to a cell outside the RAN area, WTRU performs RAN area update procedure. The nextHopChaining count may be used for deriving the security context (e.g., encryption/integrity protection keys) upon resuming the connection.

The I-RNTI is used to identify both the WTRU and the gNB that hosts the WTRU context. This is required to move the WTRU context from one gNB to another gNB when the WTRU is mobile while RRC INACTIVE. The 3GPP specification does not specify the number of bits that should be used to identify the gNB or the number of bits that should be used to identify the WTRU within the I-RNTI. The division of the total number of bits is left to the network implementation.

In System Information Block #1 (SIB1) broadcasted in a cell, there is an Information element (IE) called “useFullResumeID” that is used to instruct the WTRU either to use full or short I-RNTI when resuming the RRC connection. That is, if the WTRU resumes the connection in a cell that broadcasts the useFullResumeID flag, the WTRU will use the full I-RNTI (i.e., using the RRCResumeRequest1 message). If such a flag is not broadcasted, the WTRU resumes using the short I-RNTI (i.e., using the RRCResumeRequest message).

The RRCResumeRequest message is 48 bits long, while the RRCResumeRequest1 message is 64 bits long.

The main reason behind the concern about the message size of the RRCResumeRequest/RRCResumeRequest1 messages is that these messages are sent during initial access using transparent RLC (i.e., they cannot be segmented and must fit within one MAC transport block), and thus the message size must be kept as small as possible to ensure reliable reception even when the WTRU is at a cell edge.

The situation is similar for the case of RRCSetupRequest, where the size also is 48 bits, like the RRCResumeRequest message.

When the WTRU performs the connection setup/establishment or resume procedure, it includes (in the RRCSetupRequest or RRCResumeRequest), the establishment or resume cause. Currently, the following causes are defined.

| | |
|---|---|
| EstablishmentCause ::= | ENUMERATED { |
| | emergency, highPriorityAccess, mt-Access, mo- |

Signalling,

| | |
|---|---|
| | mo-Data, mo-VoiceCall, mo-VideoCall, mo-SMS, |
| | mps-PriorityAccess, mcs-PriorityAccess,spare6, spare5, |
| | spare4, spare3, spare2, spare1} |
| ResumeCause ::= | ENUMERATED {emergency, highPriorityAccess, mt-Access, mo- |

Signalling,

| | |
|---|---|
| | mo-Data, mo-VoiceCall, mo-VideoCall, mo-SMS, rna- |
| Update, | mps-PriorityAccess,mcs-PriorityAccess, |
| | spare1, spare2, spare3, spare4, |

spare5 }

For example, if the connection is being setup/resumed due to a voice call or video call originating from the WTRU, the WTRU will set the establishment/resume cause to mo-VoiceCall (mobile originated voice call) or mo-VideoCall (mobile originated video call). As another example, if the connection is being setup/resumed due to downlink paging indicating DL data, the WTRU will set the establishment/resume cause to one of mt-Access (mobile terminated access), highPriorityAccess, mps-PriorityAccess, or mcs-PriorityAccess (depending on the access category of the WTRU).

The mechanism used for RAN area update is sometimes referred to as a “2 step resume” procedure because the WTRU sends a ResumeRequest indicating a cell re-selection outside the RAN area, and the network responds with a Release message (e.g., including a new RAN area configuration). That is, the WTRU will remain in INACTIVE state, and the network now has information as to in which RAN area the WTRU can be accessible if there is a need to page the WTRU (e.g., arrival of DL data at the RAN that is intended for the WTRU).

### 2-Step and 4-Step Random Access

Random access can be performed either in a contention-based fashion (i.e., contention based random access (CBRA) and contention free (i.e., contention free random access (CFRA)). Two types of random access are supported in NR: 4-step RA, and 2-step RA. The 4 step RACH procedure is what was described above along with the RRC resume/setup procedure. For example, the 2-step RACH procedure may be useful in scenarios where minimizing latency is important, as the signaling exchange necessary to complete the random access procedure is reduced.

The 2-step and 4-step procedures are briefly described below:

### 4-Step Random Access Procedure:

1. 4-Step random access begins with the WTRU transmitting MSG1, which contains a preamble on PRACH. Upon MSG1 transmission, the WTRU monitors for a random access response (e.g., RAR/Msg2) from the network within a configured window.
2. Upon reception of the RAR, which contains an UL grant and a timing advance command, the WTRU applies the timing advance command and sends Msg3 using the UL grant provided in RAR.
3. Upon Msg3 transmission, the WTRU again monitors for a network response (e.g., Msg4) containing contention resolution information.
4. If contention resolution is successful, random access is complete and the WTRU begins connection. If contention resolution fails, the WTRU restarts random access via transmission of Msg1.

### 2-Step Random Access Procedure:

1. 2-step random access begins with transmission of MsgA, which includes a preamble on the Physical Random Access Channel (PRACH) and a payload on the (Physical Uplink Shared Channel (PUSCH). After MsgA transmission, the WTRU monitors for a response (e.g., MsgB) from the network within a configured window containing information regarding contention resolution.
2. If contention resolution is successful, the WTRU terminates the random access procedure. If contention resolution fails and a fallback indication is provided in MsgB, the WTRU performs Msg3 transmission using an UL grant contained within the MsgB fallback indication, and begins to monitor for contention resolution. If contention resolution again fails after Msg3 transmission, the WTRU reverts back to MsgA transmission. If the MsgA transmission fails a configured number of times, the WTRU may revert back to 4-step Random access.

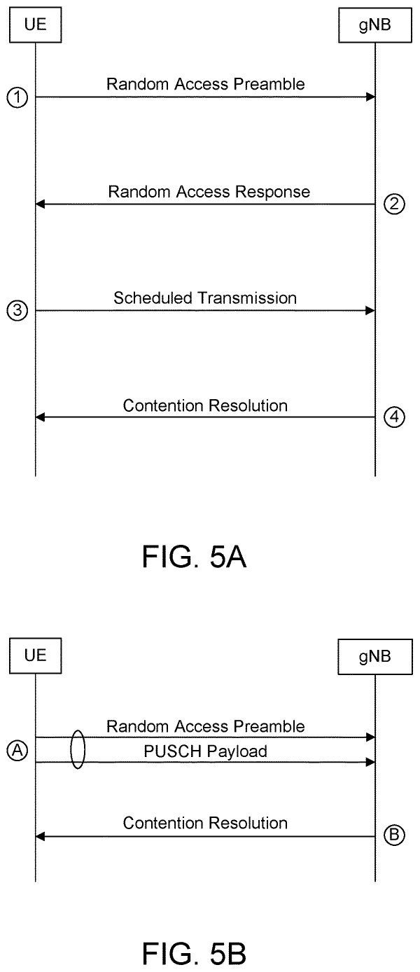

The messaging exchange for 4 and 2-step RACH can be seen in FIGS. 5A and 5B, respectively.

Which type of random access to use is selected upon initiation of the random access procedure based on network configuration. When contention free random access resources are configured, the WTRU performs 4-step or 2-step random access depending on whether the random access resources correspond to 2-step or 4-step. If contention free random access resources are not provided, the WTRU selects between 4-step and 2-step random access based on an RSRP threshold.

### Delay and Coverage Reliability

As discussed above, the size of msg3 messages (e.g., RRCSetupRequest, RRCResumeRequest, RRCResumeRequest1, etc.) are kept small to ensure reliable coverage during initial access. As such, the WTRU can only include limited information in msg3, and, particularly, a limited number of establishment or resume causes that are already mostly prespecified in 3GPP.

Thus, the network must wait until at least msg5 to obtain additional information from the WTRU, and most probably may even need to reconfigure the WTRU to get the additional information (requiring further round trip times (RTTs) before the network receives the required information).

3GPP has started standardized AI/ML related enhancements in Rel-18. Thus, more and more functionality will become available where the WTRU can give the WTRU assistance information to the network at the start of the connection setup or resume, which can be used to determine the best configuration for the WTRU (e.g., whether to configure carrier aggregation or not, whether to perform dual connectivity or not, what kind of bearer configuration to use for user data, how much data to expect from the WTRU, what will be the traffic pattern from that WTRU, etc.). Thus, by not including such assistance information in msg3, an opportunity is missed to configure the WTRU appropriately in msg4. Particularly, if the assistance information provided to the network in msg5 indicates that the current configuration is not the most suitable for the WTRU and the needs of its traffic and/or applications, then further reconfiguration will be necessary, consuming further network resources and adding to the latency. For some WTRUs and some applications (e.g., applications that have very strict delay requirements), even using the wrong configuration for a few extra RTTs during initial access may lead to performance degradation (even in the best-case scenario where the WTRU can send the assistance information in msg5, and is immediately reconfigured).

### Representative Examples for Use of Multiple WTRU Identities to Communicate WTRU and Network Conditions During Connection Setup/Resume to Reduce Overhead

In the discussion below, the terms “mode” and “state” may be used interchangeably (e.g., IDLE mode and IDLE state)

In the discussion below, the terms “data volume/type” and “traffic volume/type” may be used interchangeably.

In the discussion below, the terms “connection setup” and “connection establishment” may be used interchangeably

In the discussion below, the terms “expected”, “anticipated”, “estimated”, “predictive” and “predicted” (and their adverb variants) may be used interchangeably.

In the discussion below, the term AI/ML (Artificial Intelligence/Machine Learning) may be used to describe any model and associated learning algorithm used by the WTRU or/and network to predict future behavior (e.g., traffic prediction, measurement prediction, etc.). The model and associated learning algorithm may be assumed to utilize a large set of data collected by the WTRUs and/or network. It is assumed the network is already aware of the AI/ML capabilities of the WTRU (or it may be the network that is providing the AI/ML model to be used by the WTRU), including the prediction time horizon, confidence/accuracy of prediction (e.g., 95% confidence) and/or error margins (e.g., predicted value=x, lower margin=L, upper_margin=u; indicating the value is expected to be between x−L and x+U).

In the discussion below, the term “time horizon” may be used to refer to the time (i.e., delta time from the current time) at which a prediction is expected to be fulfilled (e.g., UL data arrives, measurement of a certain cell reaches a certain value, etc.)

Representative Examples of WTRU Configured with Multiple Identities that Depend on Current WTRU Conditions

In one embodiment, a WTRU may be configured with multiple identities (e.g., multiple sets of resume identities, e.g., full I-RNTI and short I-RNTI pairs) and may be configured to use one or another of the identities upon transitioning from the INACTIVE state to a CONNECTED state, where the particular identity used may be a function of current WTRU conditions (e.g., UL data level, etc.). With this approach, the legacy message for connection setup request or connection resume request, which has a small size for ensuring reception by the network even if the WTRU is at a cell edge, may be used to communicate current WTRU conditions to the network.

For example, the WTRU may be configured to use: a first resume identity pair (full I-RNTI_a, short I-RNTI_a), if it has pending UL data to transmit that is below a certain volume, e.g., X MBs during the resumption; a second resume identity pair (full I-RNTI_b, short I-RNTI_b), if it has pending UL data to transmit that is between X and Y MBs; and a third resume identity pair (full I-RNTI_c short I-RNTI_c), if it has pending UL data to transmit that is greater than Y MBs.

In one embodiment, a WTRU may be configured with multiple RA preambles, and may select one or more for MSG1 and/or MSGA transmission during connection setup or resume based on current WTRU conditions.

In one embodiment, a WTRU may be configured and/or indicated to use multiple RACH occasions, wherein the WTRU uses one or more of the RACH occasions during RA procedure based on current WTRU conditions.

Representative Examples of WTRU Configured with Multiple Identities that Depend on Predicted WTRU Conditions

In one embodiment, a WTRU may be configured with multiple identities (e.g., multiple sets of resume identities, e.g., full I-RNTI and short I-RNTI pairs) and may be configured to use one or another of the identities upon transitioning from the INACTIVE state to a CONNECTED state, where the particular identity used may be a function of predicted WTRU conditions (e.g., predicted UL data level, etc.).

For example, the WTRU may be configured to use: a first resume identity pair (full I-RNTI_a, short I-RNTI_a), if it predicts that it will have no more than X MBs in the UL to transmit within a given time horizon; a second resume identity pair (full I-RNTI_b, short I-RNTI_b), if it predicts that it will have between X and Y MBs to transmit in the UL within a given time horizon; and a third resume identity pair (full I-RNTI_c short I-RNTI_c), if it predicts that it will have more than Y MBs to transmit in the UL within a given time horizon.

In one embodiment, the WTRU may be configured to consider not only the predicted values or range of values in deciding the identities to use, but also confidence intervals or error margins. For example, if the WTRU has a 90% confidence that the UL traffic level predicted via AI/ML will be X MBs, and 80% confidence that it will be Y MBs, the WTRU may choose the identity associated with a data volume of X MBs.

In one embodiment, the network may send an indication in msg4 (e.g., RRC Resume, RRC Setup) indicating to the WTRU to send the predicted values. The indication may be a flag indicating to the WTRU to send all the predicted values. Alternately, the indication may be a detailed filter/indication (e.g., how many samples to indicate, minimum accuracy and/or confidence levels, minimum and/or maximum time horizon from now, etc.).

In one embodiment, the WTRU may be configured to include detailed predictions in msg 5 (e.g., RRC Resume Complete, RRC Setup Complete, etc.) based on, e.g., received indication in msg4. For example, the WTRU may include a time series prediction of the UL buffer level (e.g., a set of timestamp, value, confidence interval, lower_error_margin, upper_error_margin, etc.).

In one embodiment, a WTRU may be configured with multiple RA preambles, and may select one or more for MSG1 and/or MSGA transmission during connection setup or resume based on predicted WTRU conditions.

In one embodiment, a WTRU may be configured and/or indicated to use multiple RACH occasions, wherein the WTRU uses one or more of the RACH occasions during RA procedure as a function of predicted WTRU conditions.

Representative Examples of WTRU Configured with Multiple Identities that Depend on Current Network Conditions

In one embodiment, a WTRU may be configured with multiple identities (e.g., multiple sets of resume identities, e.g., full I-RNTI and short I-RNTI pairs) and may be configured to use one or another of the identities on transitioning from the INACTIVE state to a CONNECTED state, where the particular identity used may be a function of current network conditions (e.g., signal level of current serving cell or one or more neighbor cells, etc.).

For example, the WTRU may be configured to use: a first resume identity pair (full I-RNTI_a, short I-RNTI_a), if the current serving cell has a signal level below X dBm during the resumption; a second resume identity pair (full I-RNTI_b, short I-RNTI_b), if the current serving cell has a signal level between X and Y dBm during the resumption; and a third resume identity pair (full I-RNTI_c, short I-RNTI_c), if the current serving cell has a signal level above Y dBm during the resumption.

In one embodiment, a WTRU may be configured with multiple RA preambles, and may select one or more for MSG1 and/or MSGA transmission during connection setup or resume based on current network conditions.

In one embodiment, a WTRU may be configured and/or indicated to use multiple RACH occasions, wherein the WTRU may be configured to use one or more of the RACH occasions during RA procedure based on current network conditions.

In one embodiment, the mapping or association between the current network conditions and WTRU identities, RA preambles, RACH occasions, etc. may be based on a check regarding how the network conditions have changed between the time the WTRU was transitioned to INACTIVE/IDLE and the current conditions when the WTRU is transitioning back to CONNECTED mode. For example, the WTRU may be configured to use: a first resume identity pair (full I-RNTI_a, short I-RNTI_a) if it determines that the signal level of one or more of the serving cells (e.g., the PCell and SCells) at the current moment and at the time of the transition to INACTIVE/IDLE are the same or only slightly different (e.g., within a configured threshold); a second resume identity pair (full I-RNTI_b, short I-RNTI_b) if the signal level of the serving cells at the moment is considerably better (e.g., based on a configured threshold) than what it was during transition to INACTIVE/IDLE; and a third resume identity pair (full I-RNTI_c short I-RNTI_c) if the signal level of the serving cells at the moment is considerably worse than (e.g., based on a configured threshold) what it was during transition to INACTIVE/IDLE.

Representative Examples of WTRU Configured with Multiple Identities that Depend on Predicted Network Conditions

In one embodiment, a WTRU may be configured with multiple identities (e.g., multiple sets of resume identities, e.g., full I-RNTI and short I-RNTI pairs) and may be configured to use one or another of the identities on transitioning from the INACTIVE state to a CONNECTED state, where the particular identity used may be a function of predicted network conditions (e.g., signal level of current serving or one or more neighbor cells, etc.).

For example, the WTRU may be configured to use: a first resume identity pair (full I-RNTI_a, short I-RNTI_a), if the current serving cell's signal level is predicted to be below X dBm within a given time horizon; a second resume identity pair (full I-RNTI_b, short I-RNTI_b), if the current serving cell's signal level is predicted to be between X and Y dBm within a given time horizon; and a third resume identity pair (full I-RNTI_c, short I-RNTI_c), if the current serving cell's signal level is predicted to be above Y dBm within a given time horizon.

In one embodiment, the WTRU may be configured to consider not only the predicted values or range of values in deciding the identities to use, but also confidence intervals or error margins. For example, if the WTRU has a 90% confidence that the predicted serving cell's signal level will be below X, and 80% confidence that it will be below Y, the WTRU may choose the identity associated with a level of X dBm.

In one embodiment, the network may send an indication in msg4 (e.g., RRC Resume, RRC Setup) indicating to the WTRU to send the predicted values of the concerned network conditions. The indication may be a flag indicating to the WTRU to send all the predicted values. Alternately, the indication may be a detailed filter/indication (e.g., how many samples to indicate, minimum accuracy/confidence levels, min/max time horizon from now, etc.)

In one embodiment, the WTRU may be configured to include detailed predictions of the network conditions in msg 5 (e.g., RRC Resume Complete, RRC Setup Complete, etc.) based on, e.g., a received indication in msg4. For example, the WTRU may include a time series prediction of the serving cell's and/or neighbor cell's signal levels (e.g., a set of timestamp, value, confidence interval, lower_error_margin, upper_error_margin, etc.).

In one embodiment, a WTRU may be configured with multiple RA preambles, and may be configured to select one or more for MSG1 and/or MSGA transmission during connection setup or resume based on predicted network conditions.

In one embodiment, a WTRU may be configured and/or indicated to use multiple RACH occasions, where the WTRU may use one or more of the RACH occasions during RA procedure as a function of predicted network conditions.

### COMBINATIONS OF EMBODIMENTS

Any and all the previous solutions may be combined. For example, the mapping or association between the different identities may be based on a combination of current and predicted WTRU conditions, and/or current WTRU and network conditions, and/or current WTRU and predicted network conditions, and/or current and prediction network conditions, etc.

In one embodiment, the WTRU may choose the WTRU identity to be used in msg3 based on current WTRU or network conditions, but may include predicted value(s) of one or more WTRU and/or network conditions in msg5.

In one embodiment, the WTRU may choose the WTRU identity to be used in msg3 based on predicted WTRU or network conditions, but may include current value(s) of one or more WTRU and/or network conditions in msg5.

### Representative Examples for how the WTRU Receives the Configuration

In one embodiment, the WTRU may receive the configuration (e.g., regarding the WTRU identities, RA preambles, RACH occasions, etc., and their association/mapping to different current and/or predicted WTRU and/or network conditions) in an RRC Reconfiguration message while in CONNECTED state.

In one embodiment, the WTRU may receive these configurations during the transition to INACTIVE or IDLE state (e.g., in an RRC Release message).

### Example Method

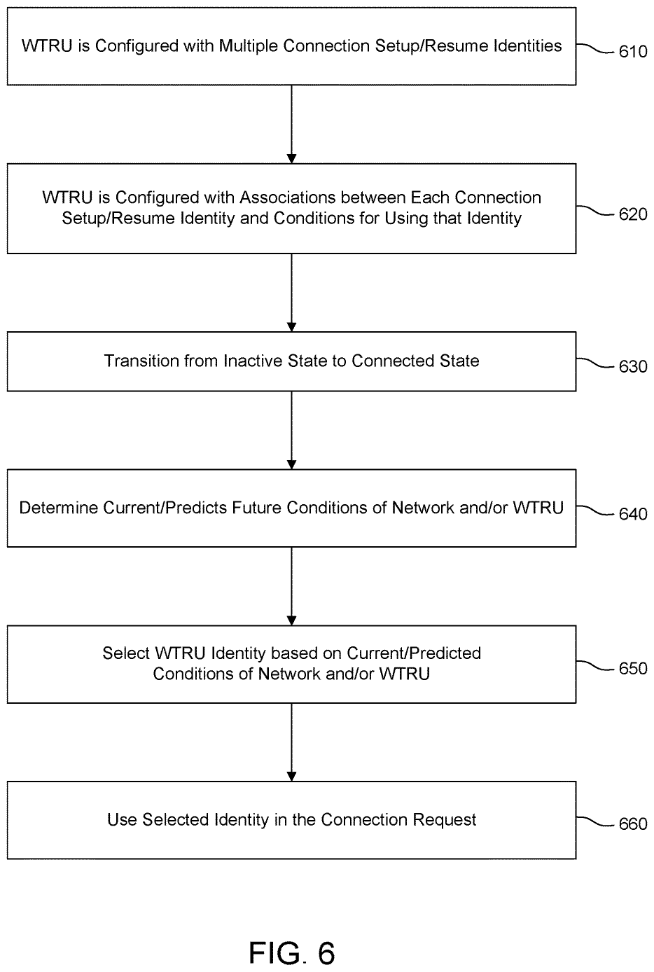

FIG. 6 is a flowchart illustrating example embodiments as described hereinabove. At 610, the network may configure the WTRU with (or indicate to the WTRU) multiple connection setup and/or connection resume identities. Each of the identities may comprise, for instance, a pair comprising a full-RNTI and short I-RNTI.

At 620, the network may further configure the WTRU with (or indicate to the WTRU) associations between each WTRU identity set and one or more conditions for use of that identity set for connection setup and/or connection resume. The conditions may include current conditions pertaining to either the WTRU or the network or any combination thereof. The conditions may include future conditions pertaining to either the WTRU or the network or any combination thereof s predicted using AI/ML modelling. The conditions may include such things as: UL data levels, predicted data levels, current signal levels of serving cells, predicted signal levels of serving cells, etc.

At 630, an event occurs that may cause the WTRU to commence transition from a first activity state, e.g., inactive, to a second activity state, e.g., RRC_CONNECTED.

At 640, the WTRU may determine one or more relevant conditions that it has been configured to base its decision as to which identity set to use for the transition to connected state.

At 650, the WTRU may select one of the identity sets based on the one or more relevant conditions as described hereinabove.

At 660, the WTRU may transmit the selected identity set to the network in a connection request (e.g., RRCSetupRequest).

### Example Process

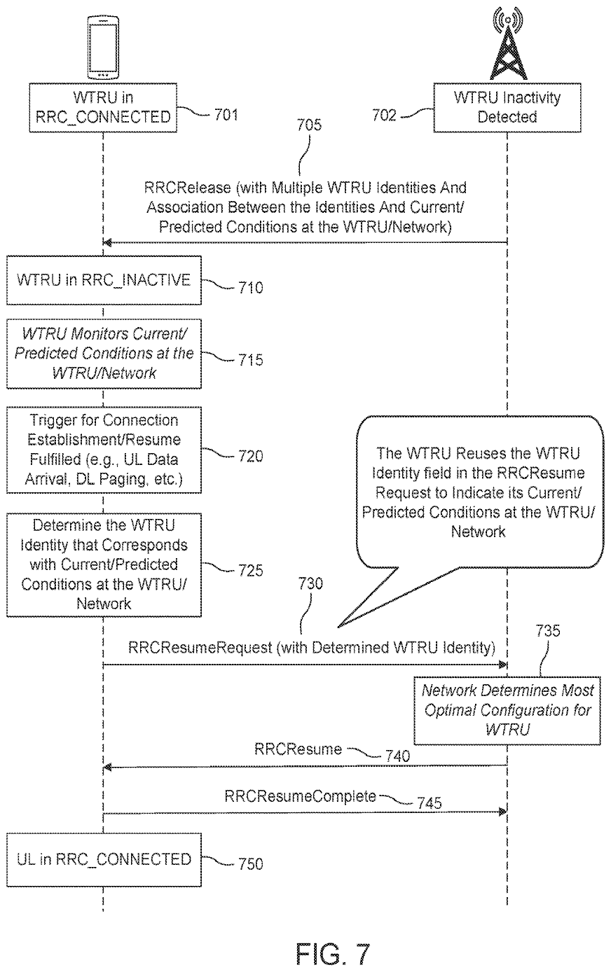

FIG. 7 is a signal flow diagram illustrating an example process, according to various embodiments. More specifically, FIG. 7 illustrates a process in which a WTRU may be configured with multiple identities (e.g., resume identities), which can be used during connection setup and/or connection resume, and that may be dependent on current and/or predicted UE and/or network conditions. As illustrated in the example of FIG. 7, at 701, the WTRU may be in connected state and, at 702, the network (e.g., a network element or node) may detect WTRU inactivity (e.g., determine that the WTRU is inactive).

In the example of FIG. 7, at 705, the WTRU may receive, from the network, a message or information, such as a RRC release message. In an embodiment, the information or the RRC release message may include or may indicate multiple WTRU identities. According to an embodiment, the RRC release message, or a separate message or information, may include or indicate associations between the identities and current and/or predicted conditions at the WTRU and/or at the network.

As further illustrated in the example of FIG. 7 at 710, in an example embodiment, the WTRU may optionally transition to an inactive state (e.g., RRC_INACTIVE). At 715, the WTRU may be configured to monitor and/or determine at least one of current and/or predicted conditions at the WTRU and/or at the network. At 720, the WTRU may be configured to detect or determine that a trigger for connection establishment and/or resume (e.g., UL data arrival, DL paging, etc.) is or has been fulfilled. At 725, based on the associations, the WTRU may be configured to determine the WTRU identity that corresponds with the determined current and/or predicted conditions at the WTRU and/or at the network.

As illustrated in the example of FIG. 7, at 730, the WTRU may be configured to transmit a message or information, such as a RRC resume request, that may include or indicate the determined WTRU identity. For example, in an example embodiment, the WTRU may reuse the WTRU identity field in the RRC resume request to indicate its current and/or predicted conditions at the WTRU and/or at the network. At 735, the network may determine the configuration (e.g., the most optimal configuration) for the WTRU, e.g., based on the information received from the WTRU. At 740, the WTRU may receive a RRC resume message from the network and, at 745, the WTRU may transmit a RRC resume complete message to the network. In one example, at 750, the WTRU may transition to connected state (e.g., RRC_CONNECTED).

### Example Method

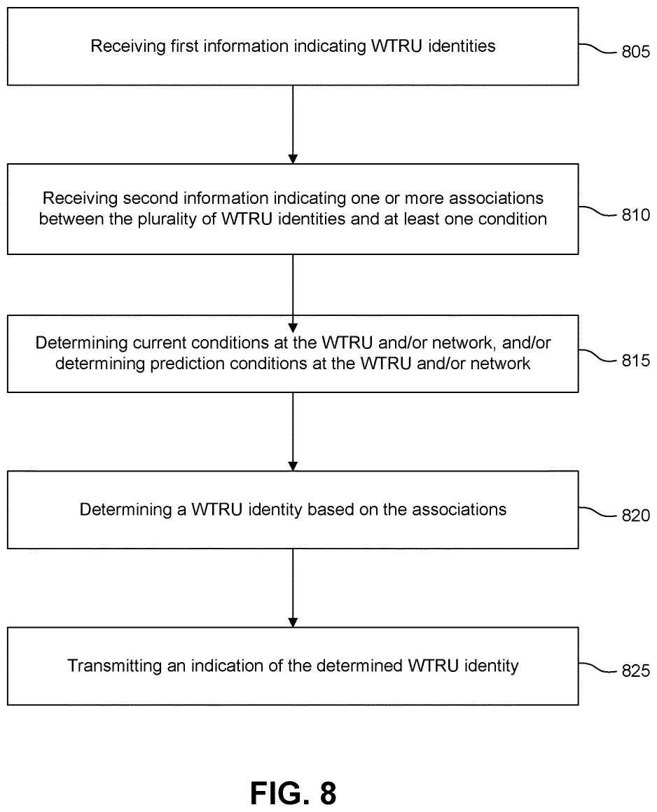

FIG. 8 is an example flow diagram illustrating an example method of connection setup and/or resume in wireless networks, according to some example embodiments. The example method of FIG. 8 and accompanying disclosures herein may be considered a generalization or synthetization of the various disclosures discussed above. For convenience and simplicity of exposition, the example of FIG. 8 may be described with reference to the architecture described with respect to FIGS. 1A-1D, for instance. However, the example method depicted in FIG. 8 may be carried out using different architectures as well. According to some embodiments, the method of FIG. 8 may be implemented by a UE or WTRU, such as the WTRU 102 described in the foregoing. It is noted that the method and/or blocks of FIG. 8 may be modified to include, or to be replaced by, any one or more of the procedures or blocks discussed elsewhere herein. As such, one of ordinary skill in the art would understand that FIG. 8 is provided as one example and modifications thereto are possible while remaining within the scope of certain example embodiments.

As illustrated in the example of FIG. 8, the method may include, at 805, receiving first information indicating a plurality of WTRU identities. In some example embodiments, the plurality of WTRU identities may include WTRU identities that are available to be used during connection setup and/or connection resume.

As further illustrated in the example of FIG. 8, at 810, the method may include receiving second information indicating one or more associations between (i) each of the plurality of identities and (ii) at least one condition. For example, the at least one condition may include at least one of current conditions and/or predicted conditions the WTRU and/or current conditions and/or predicted conditions at the network. According to certain embodiments, the first information and the second information may both be received in the same message (e.g., in a single RRC release message), or the first information and the second information may be received in separate messages. In one example, any of the first information and/or the second information may be received while the WTRU is in a connected state. In other examples, the any of the first information and/or the second information may be received while the WTRU is in a state other than the connected state.

In an embodiment, at 815, the method may include determining one or more of the current conditions at the WTRU, the current conditions at the network, the predicted conditions at the WTRU, and/or the predicted conditions at the network. According to one example, any of the current conditions at the WTRU and/or the predicted conditions at the WTRU may include, may relate to or may indicate an amount of uplink data to be transmitted by the WTRU. In one example, any of the current conditions at the network and/or the predicted conditions at the network may include, may relate to or may indicate a signal level of a cell serving the WTRU. In some embodiments, any of the predicted conditions at the WTRU and/or the predicted conditions at the network may be predicted by the WTRU using artificial intelligence/machine learning (AI/ML).

According to some embodiments, although not explicitly illustrated in FIG. 8, the method may optionally include transitioning to an inactive state based on receipt of a message, such as radio resource control (RRC) release message, where any of the current conditions at the WTRU, the current conditions at the network, the predicted conditions at the WTRU, and/or the predicted conditions at the network may be determined while in the inactive state.

As further illustrated in the example of FIG. 8, at 820, the method may include, based on the associations, determining a WTRU identity (from among the plurality of WTRU identities) that is associated with one or more of: the determined current conditions at the WTRU, the determined predicted conditions at the WTRU, the determined current conditions at the network, and/or the determined predicted conditions at the network. According to one example embodiment, the determining 820 of the WTRU identity may be performed while the WTRU is operating in a power saving state, such as an idle state or an inactive state. In one example embodiment, the determining 820 of the WTRU identity may be performed upon or after transitioning to a non-power saving state, such as a connected state.

At 825, the method may include transmitting or providing, to the network, an indication of the determined WTRU identity. According to one example embodiment, the indication of the determined WTRU identity may be transmitted in a setup or resume request message. In an example embodiment, the transmitting 825 of the indication of the determined WTRU identity may be performed upon or after transitioning from a power saving state (e.g., idle or inactive state) to a non-power saving state, such as a connected state.

### CONCLUSION

For the sake of brevity, most of the discussion above focused on the RRC Resume case. However, all the solutions are equally applicable for the case of RRC Setup (e.g., the WTRU may be configured with multiple initial UE-Identities to be used in the RRC Setup Request upon RRC connection establishment, in a similar way as the resume identities, for different current/predicted WTRU and network conditions).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶] 6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### 1 REFERENCES

[1] 3GPP, “Group Radio Access Network NR; NR and NG-RAN Overall Description”, TS 38.300, ver. 17.1.0, July 2022.

1. A method implemented in a Wireless Transmit Receive Unit (WTRU), the method comprising:
receiving first information indicating a plurality of WTRU identities;
receiving second information indicating one or more associations between (i) each of the plurality of WTRU identities and (ii) at least one condition, wherein the at least one condition comprises any of current conditions and predicted conditions at any of the WTRU and a network;
determining any of the current conditions at the WTRU, the current conditions at the network, the predicted conditions at the WTRU, and the predicted conditions at the network;
based on the associations, determining a WTRU identity that is associated with any of: the determined current conditions at the WTRU, the determined predicted conditions at the WTRU, the determined current conditions at the network, and the determined predicted conditions at the network; and
transmitting, to the network, an indication of the determined WTRU identity.

2. The method of claim 1, wherein the first information and the second information are received in a radio resource control (RRC) release message, or wherein the first information and the second information are received in separate messages.

3. The method of claim 1, wherein the plurality of WTRU identities comprise WTRU identities that are available to be used during any of connection setup and connection resume.

4. The method of claim 1, wherein any of the current conditions at the WTRU and the predicted conditions at the WTRU comprise an amount of uplink data to be transmitted by the WTRU.

5. The method of claim 1, wherein any of the current conditions at the network and the predicted conditions at the network comprise a signal level of a cell serving the WTRU.

6. The method of claim 1, wherein any of the predicted conditions at the WTRU and the predicted conditions at the network are predicted by the WTRU using artificial intelligence/machine learning (AI/ML).

7. The method of claim 1, wherein any of the first information and the second information are received while the WTRU is in a CONNECTED state.

8. The method of claim 1, comprising transitioning to an INACTIVE state or an IDLE state based on a reception of a radio resource control (RRC) release message, wherein any of the current conditions at the WTRU, the current conditions at the network, the predicted conditions at the WTRU, and the predicted conditions at the network are determined while in the INACTIVE state or the IDLE state.

9. The method of claim 1, wherein the determining of the WTRU identity comprises determining the WTRU identity upon or after transitioning to a CONNECTED state from an IDLE or INACTIVE state.

10. The method of claim 1, wherein the transmitting comprises transmitting the indication of the determined WTRU identity in a connection setup or connection resume request message that triggers the transition of the WTRU from an IDLE or INACTIVE state to a CONNECTED state.

11. A wireless transmit/receive unit (WTRU), comprising:
circuitry, including any of a transmitter, receiver, processor and memory, the circuitry configured to:
receive first information indicating a plurality of WTRU identities;
receive second information indicating one or more associations between (i) each of the plurality of WTRU identities and (ii) at least one condition, wherein the at least one condition comprises any of current conditions and predicted conditions at any of the WTRU and the network;
determine any of the current conditions at the WTRU, the current conditions at the network, the predicted conditions at the WTRU, and the predicted conditions at the network;
based on the associations, determine a WTRU identity that is associated with any of: the determined current conditions at the WTRU, the determined predicted conditions at the WTRU, the determined current conditions at the network, and the determined predicted conditions at the network; and
transmit, to the network, an indication of the determined WTRU identity.

12. The WTRU of claim 11, wherein the first information and the second information are received in a radio resource control (RRC) release message, or wherein the first information and the second information are received in separate messages.

13. The WTRU of claim 11, wherein the plurality of WTRU identities comprise WTRU identities that are available to be used during any of connection setup and connection resume.

14. The WTRU of claim 11, wherein any of the current conditions at the WTRU and the predicted conditions at the WTRU comprise an amount of uplink data to be transmitted by the WTRU.

15. The WTRU of claim 11, wherein any of the current conditions at the network and the predicted conditions at the network comprise a signal level of a cell serving the WTRU.

16. The WTRU of claim 11, wherein the WTRU is configured to predict any of the predicted conditions at the WTRU and the predicted conditions at the network using artificial intelligence/machine learning (AI/ML).

17. The WTRU of claim 11, wherein any of the first information and the second information are received while the WTRU is in a CONNECTED state.

18. The WTRU of claim 11, wherein the WTRU is caused to transition to an INACTIVE state or an IDLE state based on a reception of a radio resource control (RRC) release message, and wherein any of the current conditions at the WTRU, the current conditions at the network, the predicted conditions at the WTRU, and the predicted conditions at the network are determined while in the INACTIVE state or the IDLE state.

19. The WTRU of claim 11, wherein the WTRU is configured to determine the WTRU identity upon or after transitioning to a CONNECTED state from an IDLE or INACTIVE state.

20. The WTRU of claim 11, wherein the indication of the determined WTRU identity is transmitted in a connection setup or connection resume request message that triggers the transition of the WTRU from an IDLE or INACTIVE state to a CONNECTED state.
